(19) United States
(12) Patent Application Publication
(10) Pub. No.: US 2021/0002550 A1
(43) Pub. Date: Jan. 7, 2021

(54) WATER-SOLUBLE FLUX AND COPPER MATERIAL PICKLING METHOD

(71) Applicant: WUYI UNIVERSITY, Jiangmen (CN)

(72) Inventors: Xianhua Zeng, Jiangmen (CN); Lusheng Xing, Jiangmen (CN); Gang Huang, Jiangmen (CN); Junhua Wang, Jiangmen (CN)

(21) Appl. No.: 16/604,283

(22) PCT Filed: Dec. 3, 2018
(86) PCT No.: PCT/CN2018/118933

§ 371 Date: Oct. 10, 2019

(30) Foreign Application Priority Data
Sep. 28, 2018 (CN) 201811138505.9

(51) Int. Cl. C09K 13/00; C23G 1/10; C23C 30/00

(52) U.S. Cl. CPC C09K 13/00; C23C 30/00; C23G 1/103

(57) ABSTRACT

The present invention belongs to the technical field of solder fluxes, and in particular relates to a water-soluble flux and a copper material pickling method. The water-soluble flux provided by the present invention includes an organic acid, an alcohol ether solvent, and deionized water. The organic acid is used as an active component of the present invention, and under the action of the alcohol ether solvent, oxides and impurities on the surface of a part to be welded can be sufficiently removed, and adhering residue of an acidic substance on the surface of the part to be welded can be reduced. In the process of tin plating of the part to be welded treated by the water-soluble flux provided by the present invention, the splash of tin liquid can be effectively inhibited, and the utilization rate of tin is improved.

The present application claims priority to Chinese Patent Application CN201811138505.9, filed with National Intellectual Property Administration, PRC on Sep. 28, 2018 and entitled “WATER-SOLUBLE FLUX AND COPPER MATERIAL PICKLING METHOD”, which is incorporated herein by reference in its entirety.

### TECHNICAL FIELD

The present invention belongs to the technical field of solder fluxes, and in particular relates to a water-soluble flux and a copper material pickling method.

### BACKGROUND

A copper wire is a metal material which is widely used. When the copper wire is used as a wire and cable material, the surface of the copper wire is usually covered with a rubber protective layer, to avoid the influence of the external environment on the copper wire. The metal copper is directly in contact with the rubber protective layer, which easily leads to the problems that the rubber protective layer is sticky and the copper wire blackens, so that the use performance of a cable is reduced. Therefore, the surface of copper wire needs to be coated with tin, to improve the service life of the cable.

A hot tin plating process has many advantages such as low equipment investment, high work efficiency, and simple operation. A required tin layer can be formed on the surface of copper by using a hot tin plating process. The conventional hot tin plating process includes paying-off-annealing-cooling-drying-pickling-tinning-rewinding steps, where the pickling step is used to remove impurities and oxides on the surface of a copper material to be plated, and through this step, not only can the copper material suitable for tin plating be obtained, but also the use performance of the copper material is improved. Therefore, a pickling reagent, namely a flux, has received extensive attention.

The conventional flux is a hydrochloric acid solution. The flux can thoroughly remove impurities and oxides on the surface of the copper material to be plated, and improve the tin plating effect. However, during tin plating, liquid tin splashes easily, so that a large amount of tin slag is generated, and the utilization rate of tin is reduced.

### SUMMARY

An objective of the present invention is to provide a water-soluble flux and a copper material pickling method. Impurities and oxides on the surface of a copper material can be completely removed by using the water-soluble flux provided by the present invention to pickle the copper material. The amount of residue on the surface of a copper wire is small, the splash of liquid tin in the tin plating step is reduced, and the utilization rate of tin is improved.

To achieve the above objective, the present invention provides the following technical solution:

A water-soluble flux, including the following components: an organic acid, an alcohol ether solvent, and deionized water.

Preferably, the water-soluble flux includes the following components by mass parts: 10-20 parts of the organic acid, 1-10 parts of the alcohol ether solvent and 70-90 parts of the deionized water.

Preferably, the organic acid includes formic acid and/or acetic acid.

Preferably, the alcohol ether solvent includes one or more of ethylene glycol monobutyl ether, dipropylene glycol methyl ether, diethylene glycol monoethyl ether, and tripropylene glycol monomethyl ether.

Preferably, the alcohol ether solvent is ethylene glycol monobutyl ether and tripropylene glycol monomethyl ether.

Preferably, the ratio of the mass of the ethylene glycol monobutyl ether to the mass of the tripropylene glycol monomethyl ether is (3-5):1.

The present invention provides a copper material pickling method, including:

mixing the water-soluble flux described in the above technical solution with water to obtain a pickling solution; and

pickling a copper material with the pickling solution.

Preferably, the ratio of the mass of the water-soluble flux to the mass of the water is 1:(3-4).

Preferably, the pickling is performed by making the copper material pass through the pickling solution, and the passing speed is 30-50 m/min.

Preferably, the method further includes tin-plating the pickled copper material, where the time interval between pickling and tin plating is 0.7-1.5 s.

The water-soluble flux provided by the present invention includes an organic acid, an alcohol ether solvent, and deionized water. The organic acid is used as an active component of the present invention, and under the action of the alcohol ether solvent, oxides and impurities on the surface of a part to be welded can be sufficiently removed, and adhering residue of an acidic substance on the surface of the part to be welded can be reduced. In the process of tin plating of the part to be welded treated by the water-soluble flux provided by the present invention, the splash of tin liquid can be effectively inhibited, and the utilization rate of tin is improved.

### BRIEF DESCRIPTION OF THE DRAWINGS

FIG. 1 is a real product view before and after pickling of a copper material according to Embodiment 1 of the present invention.

### DETAILED DESCRIPTION

The present invention is further described below with reference to the accompanying drawings and embodiments.

The present invention provides a water-soluble flux, including the following components: an organic acid, an alcohol ether solvent, and deionized water.

By mass parts, the water-soluble flux provided by the present invention preferably includes 10-20 parts of the organic acid, 1-10 parts of the alcohol ether solvent and 70-90 parts of the deionized water.

The water-soluble flux provided by the present invention preferably includes, by mass parts, 10-20 parts, more preferably 12-18 parts, still more preferably 13-15 parts, of the organic acid. In the present invention, the organic acid preferably includes formic acid and/or acetic acid, more preferably formic acid; when the organic acid is the formic acid and the acetic acid, the ratio of the mass of the formic acid to the mass of the acetic acid is preferably (1-5):1, more preferably (2-4):1, and still more preferably 3:1. The present invention preferably uses the organic acid that has a lower boiling point and is easy to volatilize as an active component, which can reduce the residue of an acidic component on the basis of ensuring the effect of removing oxides on the surface of a copper material, and avoid the splash of tin liquid caused in the subsequent tin plating process.

Based on the mass part of the organic acid, the water-soluble flux provided by the present invention preferably includes, 1-10 parts, more preferably 3-7 parts, still more preferably 4-5 parts, of the alcohol ether solvent. In the present invention, the alcohol ether solvent preferably includes one or more of ethylene glycol monobutyl ether, dipropylene glycol methyl ether, diethylene glycol monoethyl ether, and tripropylene glycol monomethyl ether. When the alcohol ether solvent is a component, the alcohol ether solvent is preferably 2-butoxy ethanol, dipropylene glycol methyl ether and diethylene glycol monoethyl ether; when the alcohol ether solvent is two components, the alcohol ether solvent is preferably a mixture of ethylene glycol monobutyl ether and tripropylene glycol monomethyl ether; and the ratio of the mass of the ethylene glycol monobutyl ether to the mass of the tripropylene glycol monomethyl ether is preferably (3-5):1, more preferably 4:1. In the present invention, the alcohol ether solvent can reduce the surface tension of the water-soluble flux, further reduce the residue of the components of the water-soluble flux on the surface of a part to be welded, reduce the amount of tin slag generated, and improve the utilization rate of tin.

Based on the mass part of the organic acid, the water-soluble flux provided by the present invention preferably includes 70-90 parts, more preferably 75-85 parts, still more preferably 78-82 parts, of the deionized water. In the present invention, the deionized water can sufficiently disperse the organic acid and the alcohol ether solvent, promote the contact between the organic acid, the alcohol ether solvent and an oxide at a to-be-welded position, and improve the effect of removing the oxide at the to-be-welded position.

The present invention has no special requirement for a method for preparing the water-soluble flux, and it is preferred that the above components are mixed according to the usage amount and stirred uniformly.

The present invention further provides a copper material pickling method, including:

mixing the water-soluble flux described in the above technical solution with water to obtain a pickling solution; and

pickling a copper material with the pickling solution.

In the present invention, the water-soluble flux described in the above technical solution is mixed with water to obtain a pickling solution. In the present invention, the water is preferably deionized water. In the present invention, the ratio of the mass of the water-soluble flux to the mass of the water is preferably 1:(3-4), more preferably 1:(3.2-3.7), still more preferably 1:(3.4-3.6).

After the pickling solution is obtained, in the present invention, a copper material is pickled with the pickling solution. The present invention has no special requirements for the copper material, and a copper material which is well known to those skilled in the art and which needs to be welded may be used. In an embodiment of the present invention, the copper material preferably includes a copper wire, more preferably a copper wire for the preparation of wires and cables. The present invention has no special requirement for the usage amount of the copper material and the pickling solution, as long as the copper material can pass through the pickling solution in an immersed state.

In the present invention, the pickling is performed by making the copper material pass through the pickling solution; and the passing speed is preferably 30-50 m/min, more preferably 35-45 m/min, still more preferably 40 m/min. In the present invention, it is preferable to limit the passing speed of the copper material as described above, and it is possible to improve the processing efficiency of the copper material on the basis of ensuring the effect of removing the oxide on the surface of the copper material.

After pickling, the present invention preferably further includes tin-plating the pickled copper material, where the time interval between the pickling and tin plating is preferably 0.7-1.5 s, more preferably 0.9-1.4 s, still more preferably 1 s. The present invention has no special requirement on a specific mode of tin plating, and a mode of tin plating well known to those skilled in the art can be used. In a specific embodiment of the present invention, during tin plating, the temperature of the tin liquid is preferably 250-260° C., and more preferably 255° C.

In the present invention, the copper material is preferably treated in the above mode, so that the oxides and impurities on the surface of the copper material can be sufficiently removed, and the acidic components remaining on the surface of the copper material are less. When tin plating is performed, the tin liquid splash can be reduced and the amount of tin slag generated is reduced, thereby achieving the goal of improving the utilization rate of the tin liquid.

The water-soluble flux and the copper material pickling method provided by the present invention are described in detail below with reference to the embodiments, which should not be construed as limiting the protection scope of the present invention.

### Embodiment 1

Components were mixed according to the usage amounts shown in Table 1 to obtain a water-soluble flux; and the obtained water-soluble flux was mixed with water at a mass ratio of 1:3 to obtain a pickling solution.

A copper wire passed through the pickling solution at a speed of 40 m/min for pickling, and then tin plating was performed; the interval between the tin plating and pickling was 1.05 s; that is, the distance between tin plating and pickling was 70 cm; and the temperature of the tin liquid was 250-260° C.

### Embodiment 2

A water-soluble flux was prepared according to the usage amount shown in Table 1. A copper wire passed through a pickling solution at a rate of 45 m/min, and the interval between pickling and tin plating was 0.9 s, and the rest was the same as that of Embodiment 1.

### Embodiment 3

A water-soluble flux was prepared according to the usage amount shown in Table 1. A copper wire passed through a pickling solution at a rate of 42 m/min, and the interval between pickling and tin plating was 1 s and the rest was the same as that of Embodiment 1.

### Embodiments 4-5

A water-soluble flux was prepared according to the usage amount shown in Table 1 and the rest was the same as that of Embodiment 1.

### REFERENCE EXAMPLE 1

A copper material was treated with a hydrochloric acid solution having a mass concentration of 5% as a flux, and the treatment was carried out in the same manner as in Embodiment 1.

TABLE 1
Components and usage amounts (by mass parts)
of water-soluble fluxes in Embodiments 1-5

| Embodiment | | 1 | 2 | 3 | 4 | 5 |
|---|---|---|---|---|---|---|
| Organic | Formic acid | 0 | 0 | 20 | 8 | 10 |
| acid | Acetic acid | 15 | 10 | 0 | 5 | 2 |
| Alcohol | Ethylene glycol monobutyl ether | 0 | 0 | 10 | 0 | 4 |
| ether | Dipropylene glycol methyl ether | 0 | 1 | 0 | 0 | 0 |
| solvent | Diethylene glycol monoethyl ether | 5 | 0 | 0 | 0 | 0 |
| | Tripropylene glycol monomethyl ether | 0 | 0 | 0 | 3 | 1 |

| | | | | | |
|---|---|---|---|---|---|
| Water | 80 | 89 | 70 | 84 | 80 |

Performance Characterization and Results

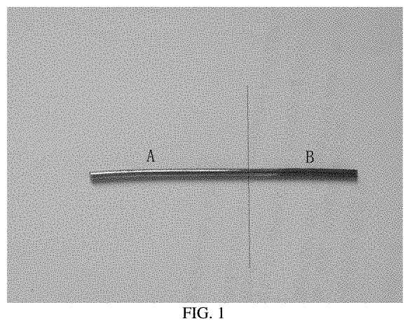

The cleaning effect of the water-soluble flux was characterized by observing the morphology of the copper material before pickling and after pickling. The results are shown in FIG. 1. In FIG. 1, a part B is a morphological view of the copper material before cleaning in Embodiment 1, where a copper wire is dark black; a part A is a morphological view of the copper material after cleaning, and the copper wire has a bright copper color. From the comparison results of the parts A and B of FIG. 1, it can be seen that the copper material after cleaning is exposed sufficiently, showing that the water-soluble flux can remove oxides and impurities from the surface of the copper wire. The test results of the rest embodiment were the same, and wires with sufficiently exposed copper were obtained.

The effects of the water-soluble fluxes of Embodiments 1-5 and the flux of Reference Example 1 on the tin plating process were qualitatively characterized by observing the splash of tin liquid and the morphology of a tin plating layer in the tin plating process. Test results are listed in Table 2.

The utilization rate of tin was calculated according to the total amount of tin liquid and the mass of tin in the tin plating layer on the surface of the copper material. The utilization rate of tin (%)=the mass of tin in the tin plating layer on the surface of the copper material/the total mass of tin liquid, and the calculation results are listed in Table. 2.

TABLE 2
Test results of cleaning performances of fluxes
of Embodiments 1-5 and Reference Example 1

| | Splash of | Morphology of a | Utilization |
|---|---|---|---|
| Test results | tin liquid | tin plating layer | rate of tin |
| Embodiment 1 | Less | Bright | 59.1% |
| Embodiment 2 | Much less | Bright | 59.8% |
| Embodiment 3 | Much less | Bright | 61.2% |
| Embodiment 4 | Less | Bright | 59.4% |
| Embodiment 5 | Much less | Bright | 60.0% |
| Reference Example 1 | Severe | Bright | 47% |

It can be seen from the test results of Table 2 that the water-soluble flux provided by the present invention can reduce the residual amount of the flux on the surface of the copper wire compared with a conventional hydrochloric acid solution flux without affecting the effect of removing an oxide, and reduce the splash of tin liquid; and the obtained tin plating layer has a good morphology, indicating that the water-soluble flux provided by the present invention can meet the actual needs of production; and the utilization rate of the tin liquid is close to 60%, which is improved obviously compared with a utilization rate of 47% achieved in Reference Example 1.

It can be seen from the above embodiments that the water-soluble flux provided by the present invention takes the organic acid as an active component, and can ensure the effect of removing the oxides and impurities on the surface of the copper material under the action of the alcohol ether solvent; and the organic acid and the alcohol ether solvent are easy to remove and have less residue on the surface of the copper material. Moreover, the organic acid and alcohol ether solvent used do not generate harmful gases at high temperature, and the environmental friendliness is good.

The organic acid and the alcohol ether solvent are used as functional components of the water-soluble flux according to the present invention, which can reduce the generation of tin slag and improve the utilization rate of tin.

The water-soluble flux provided by the present invention has a simple preparation process and a simple use process, and is suitable for mass industrial production and use.

The above description of the embodiment is only for helping to understand the method of the present invention and its core idea. It should be noted that, several improvements and modifications may be made by persons of ordinary skill in the art without departing from the principle of the present invention, and these improvements and modifications should also be considered within the protection scope of the present invention. Various modifications to these embodiments are readily apparent to persons skilled in the art, and the generic principles defined herein may be practiced in other embodiments without departing from the spirit or scope of the present invention. Thus, the present invention is not limited to the embodiments shown herein but falls within the widest scope consistent with the principles and novel features disclosed herein.

1. A water-soluble flux, comprising the following components: an organic acid, an alcohol ether solvent, and deionized water.

2. The water-soluble flux according to claim 1, comprising the following components by mass parts, 10-20 parts of the organic acid, 1-10 parts of the alcohol ether solvent and 70-90 parts of the deionized water.

3. The water-soluble flux according to claim 1, wherein the organic acid comprises formic acid and/or acetic acid.

4. The water-soluble flux according to claim 1, wherein the alcohol ether solvent comprises one or more of ethylene glycol monobutyl ether, dipropylene glycol methyl ether, diethylene glycol monoethyl ether, and tripropylene glycol monomethyl ether.

5. The water-soluble flux according to claim 4, wherein the alcohol ether solvent is ethylene glycol monobutyl ether and tripropylene glycol monomethyl ether.

6. The water-soluble flux according to claim 5, wherein the ratio of the mass of the ethylene glycol monobutyl ether to the mass of the tripropylene glycol monomethyl ether is (3-5):1.

7. A copper material pickling method, comprising:
mixing the water-soluble flux according to claim 1 with water to obtain a pickling solution; and
pickling a copper material with the pickling solution.

8. The pickling method according to claim 7, wherein the ratio of the mass of the water-soluble flux to the mass of the water is 1:(3-4).

9. The pickling method according to claim 7, wherein the pickling is performed by making the copper material pass through the pickling solution, and the passing speed is 30-50 m/min.

10. The pickling method according to claim 7, further comprising tin-plating the pickled copper material, wherein the time interval between pickling and tin plating is 0.7-1.5 s.

11. The water-soluble flux according to claim 2, wherein the organic acid comprises formic acid and/or acetic acid.

12. The water-soluble flux according to claim 2, wherein the alcohol ether solvent comprises one or more of ethylene glycol monobutyl ether, dipropylene glycol methyl ether, diethylene glycol monoethyl ether, and tripropylene glycol monomethyl ether.

13. The water-soluble flux according to claim 12, wherein the alcohol ether solvent is ethylene glycol monobutyl ether and tripropylene glycol monomethyl ether.

14. The water-soluble flux according to claim 13, wherein the ratio of the mass of the ethylene glycol monobutyl ether to the mass of the tripropylene glycol monomethyl ether is (3-5):1.

15. A copper material pickling method, comprising:
mixing the water-soluble flux according to claim 2 with water to obtain a pickling solution; and
pickling a copper material with the pickling solution.

16. The pickling method according to claim 15, wherein the ratio of the mass of the water-soluble flux to the mass of the water is 1:(3-4).

17. The pickling method according to claim 15, wherein the pickling is performed by making the copper material pass through the pickling solution, and the passing speed is 30-50 m/min.

18. The pickling method according to claim 8, wherein the pickling is performed by making the copper material pass through the pickling solution, and the passing speed is 30-50 m/min.

19. The pickling method according to claim 16, wherein the pickling is performed by making the copper material pass through the pickling solution, and the passing speed is 30-50 m/min.

20. The pickling method according to claim 8, further comprising tin-plating the pickled copper material, wherein the time interval between pickling and tin plating is 0.7-1.5 s.
